(19) United States
(12) Patent Application Publication
(10) Pub. No.: US 2010/0269535 A1
(43) Pub. Date: Oct. 28, 2010

(54) PYTHON FOR COOLING BEVERAGE LINES

(75) Inventor: Riccardo Guadalupi, Zanica (IT)

Correspondence Address: LUCAS & MERCANTI, LLP, 475 PARK AVENUE SOUTH, 15TH FLOOR, NEW YORK, NY, 10016, US

(73) Assignee: VIN SERVICE S.R.L., Zanica (IT)

(21) Appl. No.: 12/161,376

(22) PCT Filed: Dec. 5, 2006
(86) PCT No.: PCT/IB2006/003464

§ 371 Date: Sep. 9, 2008

(30) Foreign Application Priority Data
Jan. 23, 2006 (IT) MI2006U0000021

(51) Int. Cl. F25D 3/00; B67D 7/80; F25D 17/06

(52) U.S. Cl. 62/393; 222/146.6; 62/419

(57) ABSTRACT

A device for cooling one or more delivery ducts (1a, 1b, 1c, 1d, 1e) for liquids in a beverage dispensing apparatus of a type comprising at least one tubular body (2), the delivery ducts and at least one conveying duct (3) for a forced flow of a cooled fluid being housed therein. Said tubular body (2) of the device comprises at least one inflow section (7) for the cooled fluid, which is fluidically communicated with this conveying duct, and at least one outflow section (6a, 6b, 8) for the cooled fluid, which is placed at a higher height than the inflow section.

### FIELD OF THE INVENTION

The present invention relates to a device for cooling one or more delivery ducts for liquids in a beverage dispensing apparatus, particularly of a type commonly used in commercial premises for drawing or serving beverages intended for final user consumption.

### PRIOR ART

Dispensing apparatuses for those beverages that are intended to be drawn at lower temperatures than room temperature, such as carbonated beverages, or beer, usually comprise at least one cooling device mainly having the aim of maintaining the beverages provided within the beverage storage containers at the desired dispensing temperature, or at a temperature slightly lower than desired.

These cooling devices are usually provided with an insulated chamber within which said beverage storage containers are inserted and from which the delivery ducts for the liquids corresponding to the various beverages branch off, which are fluidically connected to the storage containers and directed to the drawing or serving taps.

However, the fluidic line consisting of the beverage delivery ducts, extending from each storage container to the delivery taps, can also be quite long, this entailing a sensible heating of the liquids contained therein. Furthermore, regardless of the length of said lines, when the beverage liquids stagnate within these lines outside the cooling chamber of the storage containers, they are subjected to a sensible heating that can make the beverage unusable.

Particularly, mainly when the beverage contained within the delivery ducts is of a type pre-mixed with carbon dioxide, or beer, for example, the temperature gradient that may occur in the liquid between the storage container and dispensing tap can cause a serious deterioration in the beverage quality by causing the carbon dioxide molecules to be dissociated from the liquid forming the beverage.

In order to avoid this drawback, it is thus known to provide suitable means for cooling not only the storage container of each beverage, but also the delivery ducts joining the storage container to the several delivery taps.

According to a rather widespread technique, these means for cooling the beverage delivery ducts comprise a cooling circuit having tubes within which a cooled liquid substance, such as water or glycol, is recycled, usually by means of a pump, and a refrigerating machine that can be also used for refrigerating the beverage storage containers. The liquid substance of the cooling circuit is maintained at a suitable refrigeration temperature by said refrigerating machine and the tubes of the cooling circuit are then arranged in contact with or proximate to said beverage delivery ducts such as to absorb calories, substantially by conduction, from the latter.

The European Patent Application EP-A-0 928 772, in the name of the Applicant, discloses, in a preferred embodiment thereof, a beverage dispensing apparatus in which the delivery ducts for the beverages are caused to run in suitable metal blocks, with tubes of a cooling circuit being also arranged therein, which are suitable to maintain the beverages at the proper temperature, mainly when the latter stagnate within the respective delivery ducts.

British Patent Application GB 2 381 574, to MILLER et al., teaches to provide a refrigerating circuit for beverage delivery ducts, which is shaped such that these ducts are inserted within a chamber in which a liquid cooling agent, such as water or glycol, is circulated. The liquid cooling agent is refrigerated by a suitable refrigerating machine and forced into the circuit by means of a pump.

Both technical solutions described above provide an effective refrigeration of the beverage delivery ducts, even though they suffer from the drawback of requiring a suitable pump and a fluid-tight closed circuit for recycling the cooling agent, with a consequent increase in the complexity of the apparatus and reduction in the general reliability of the beverage dispensing apparatus.

A solution similar to those discussed above, and which substantially has the same drawbacks, is described in U.S. Pat. No. 3,889,487 to FRANKFURT, wherein the cooling agent that forcibly circulates within a fluid-tight closed circuit that has the beverage delivery ducts being placed therein, is air.

Means are also known for refrigerating the delivery ducts of beverages in apparatuses for dispensing the latter in which no thermal separation is provided between the cooling chamber where the beverage storage containers are placed and the columns leading to the drawing or serving tap. The cooled atmosphere in which these storage containers are placed in the dispensing apparatus is thus the same in which the beverage delivery lines are placed. Patent Application WO 87/02975 to HEINEKEN discloses a similar beverage dispensing apparatus.

This technical solution, though simple to implement, however, requires the use of beverage delivery ducts of reduced length, the use of a refrigerating machine having a suitable power, and however has proved to be poorly effective.

Finally, cooling devices for beverage delivery ducts are known, which comprise a tubular body, within which said delivery ducts are inserted, and a further duct in which a forced airflow is blown, which has been previously cooled by a refrigerating machine. The conveying duct for the cooled airflow is fitted within said tubular body, such as to absorb thermal energy from the beverage delivery ducts by conduction, and is also opened at the one end thereof that is placed within the tubular body at the top end of the latter, such as to dissipate the cooled airflow within the tubular body.

Though very simple, this solution is however poorly effective, both because it requires that the conveying duct for the cooled air has a not excessively small section, thus entailing the use of an outer tubular body of a considerable size, both because the airflow exiting the duct at the top of the tubular body contributes just a little to the cooling of the delivery ducts and is released in the external environment.

Furthermore, in the case where this opening of the forced airflow duct is placed at the so-called drawing “column”, i.e. that envelope for the delivery ducts of the dispensing devices which is externally arranged on the dispensing counter, on which the beverage dispensing taps are also arranged, and this “column”, as often happens, is made of metal, the outflow of the cooled air from the opening of said conveying duct normally causes a phenomenon of deep and sudden refrigeration of the column, with the consequent formation of a layer of unsightly and unhygienic condensate on the outer surface of the latter.

It is thus an object of the present invention to provide a device for cooling delivery ducts for liquids in a beverage dispensing apparatus that does not suffer from the drawbacks of the prior art, and is thus simple to manufacture and very effective.

Another object of the present invention is to provide a cooling device for said beverage delivery ducts which, though using a forced airflow, does not require this forced flow to be recycled in a closed circuit, and also does not cause condensate phenomena on the dispensing columns.

### SUMMARY OF THE INVENTION

These and other objects are achieved by the cooling device according to the first independent claim and the following dependent claims.

The device for cooling one or more delivery ducts for liquid in a beverage dispensing apparatus, according to the present invention, is of the type comprising a tubular body, said delivery ducts and at least one conveying duct for a forced flow of a cooled fluid being housed therein. Said tubular body of the cooling device further comprises at least one inflow section for the cooled fluid, which is fluidically communicated with this conveying duct, and at least one outflow section for the cooled fluid, the outflow section being arranged at a higher height than the inflow section.

Thereby, the forced flow of cooled fluid, preferably air, is blown to the (usually metal-made) delivery ducts from the bottom up, which ducts are contained within said tubular body that is preferably made of insulating material, thus allowing the heat to be transferred from the delivery ducts to the airflow both by conduction, and by convection. This makes the present device sensibly effective in refrigerating the delivery ducts of beverages in apparatuses for dispensing the latter.

Furthermore, as the recycling of this forced flow of cooled fluid is not provided, the device is very simple to manufacture.

According to a preferred aspect of the present invention, the outflow section of the tubular body comprises a plurality of holes that are arranged in correspondence to at least one region of the outer side surface of this tubular body.

Thereby, the fluid flow exiting the tubular body is divided into a series of flows with reduced flow rate at low temperature, which are induced to flow towards lower heights of the tubular body due to the convective movements.

In the case where a similar outflow section of the tubular body is arranged within a so-called drawing “column” made of metal, for example proximate to the beverage drawing tap, this outflow section, as the Applicant has found, does not substantially cause the instantaneous refrigeration of the metal column, and thus does not contribute to generate an undesired layer of condensate on the outer surface of the column.

### BRIEF DESCRIPTION OF THE DRAWINGS

A preferred embodiment of a cooling device according to a particular aspect of the present invention will be now described, only by way of example, with reference to the annexed figures, wherein:

FIG. 1 is an axonometric view of a part of a cooling device according to a particular aspect of the present invention; and

FIG. 2 is a schematic sectional view of part of said device as illustrated in FIG. 1.

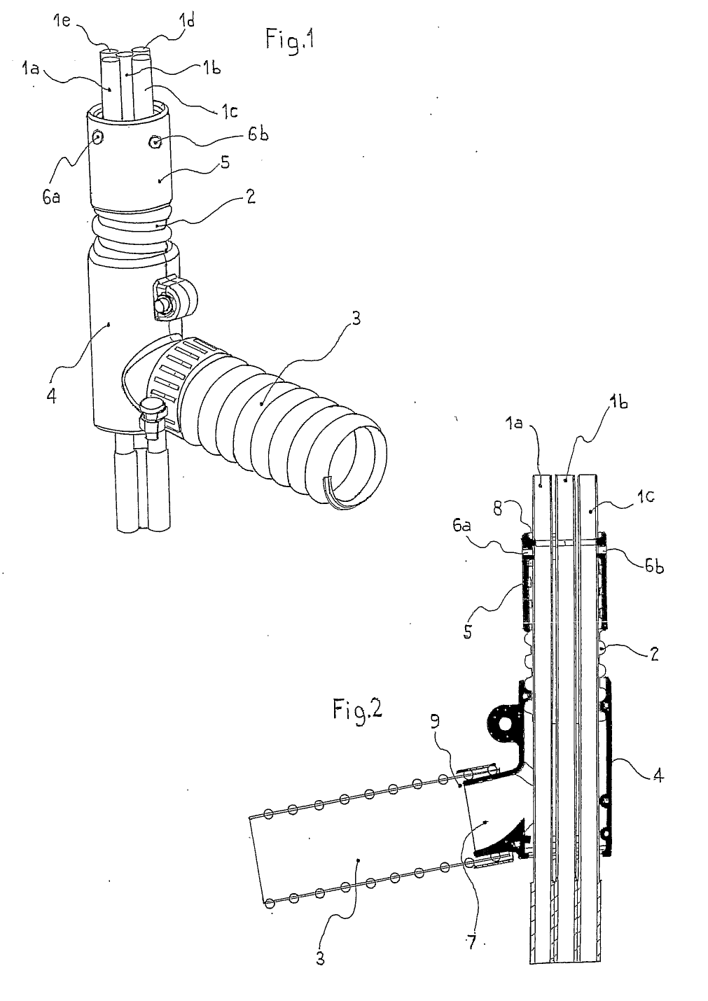

### DETAILED DESCRIPTION OF A PREFERRED EMBODIMENT OF THE INVENTION

With general reference to the figures, the cooling device according to a particular aspect of the present invention, comprises a series of delivery ducts 1a, 1b, 1c, 1d, 1e for the liquids composing the beverages to be dispensed, which are interposed between respective storage containers (not shown) and one or more dispensing taps (also not shown).

These delivery ducts 1a, 1b, 1c, 1d, 1e are arranged within a tubular body 2 that, in the particular embodiment as illustrated herein, leads the ducts 1a, 1b, 1c, 1d, 1e till within the drawing column, at the dispensing taps.

The delivery ducts 1a, 1b, 1c, 1d, 1e can be preferably made of metal, at least the tract thereof that is inserted within the tubular body 2, and the latter, usually cylindrical with circular section, can be made of insulating material, and particularly plastics, having any suitable length.

The device as illustrated herein further comprises a conveying duct 3 for a forced flow of a cooled fluid, preferably atmospheric air, which is produced by a refrigerating machine (for example, the so-called “refrigerator counter” in which the beverage storage containers are placed) being provided with suitable means for generating said forced airflow, which consist—by way of example—of a fan with suitable prevalence.

The conveying duct 3 for the forced flow of cooled air has an outlet section 9 being connected to an opening 7 of a three-way (Y-shaped) pipe joint 4 that is configured for joining this conveying duct 3 with the tubular body 2. The pipe joint 4 is thus an inlet section for the air cooled within the tubular body 2, thereby allowing the low-temperature forced airflow to refrigerate the delivery ducts 1a, 1b, 1c, 1d, 1e being arranged within the tubular body 2.

The tubular body 2 also has an outflow section for the cooled air flowing therein which comprises, according to a particular aspect of the present invention, a cap 5 provided with holes 6a, 6b, and/or vents 8 which fluidically connect the inside of the body 2 to the outer environment of the latter.

Advantageously, this outflow section 5, 6a, 6b, 8 of the tubular body 2 is arranged at a higher height than that at which said inflow section 4, 7 of the body 2 is arranged, such as to facilitate the thermal exchange between the airflow within the tubular body 2 and the delivery ducts 1a, 1b, 1c, 1d, 1e, preferably throughout the extension of the body 2.

According to a preferred aspect of the present invention, the holes 6a, 6b of the outflow section of the tubular body 2 are annularly arranged along a region of the outer surface of body 2, when the latter is cylindrical, and also have such a size as to allow the cooled air to flow out of body 2 with a reduced flow rate. Thereby, the fluidic flows exiting from the holes 6a, 6b, which consist of low-temperature air (for example, +4° C.) at low flow rates, flow to lower heights of the tubular body 2, and are replaced with a warmer airflow that has been previously provided about the body 2. In the case where the body 2 is fitted within a metal drawing column, then these flows of cooled air exiting the holes 6a, 6b will have a minimum influence on the possible formation of condensation on the outer surface of this drawing column.

The cap 5, in the particular embodiment as shown herein, also comprises vents 8 consisting of suitable gaps being provided between the delivery ducts 1a, 1b, 1c, 1d, 1e and the top end section of the cap 5. These vents 8 that, similarly to the holes, 6a, 6b, are shaped to allow the outflow of the airflow at not high flow rates, increase the airflow outlet capacity from the tubular body 2.

Furthermore, if the end section of body 2 is placed within a drawing column substantially at the beverage dispensing taps, the flows exiting the vents 8 can blow on these dispensing taps, thus causing the latter to refrigerate, as desired.

The operation of the device illustrated in the figures is as follows.

After the refrigerating machine, which may possibly contain the beverage storage containers, has been operated along with said means for generating a forced airflow, for example a fan placed within the cooling chamber, such as described in U.S. Pat. No. 3,889,487, the cooled airflow is induced to flow within the conveying duct 3 and from the latter, through the pipe joint 4, is passed through the tubular body 2.

From here, the cooled airflow, after it has refrigerated the delivery ducts 1a, 1b, 1c, 1d, 1e, preferably made of metal, and thus the liquid contained therein, due to the conduction and convection phenomena, as stated above, is released in low-flow rate streams from the holes 6a, 6b and vents 8 with which the cap 5 is provided.

In the case where the cap 5 is placed at the dispensing taps within a drawing column, the outlet of a certain amount of air at low temperature from the vents 8, and also from the holes 6a, 6b, at these taps, would contribute to cool the latter as well.

In practice, it has been found that the device as described above allows obtaining an effective refrigeration of the beverage delivery ducts 1a, 1b, 1c, 1d, 1e also within the drawing columns thereof, without thereby causing undesired phenomena of condensation on the outer surfaces of the columns.

1. A device for cooling one ere or more delivery ducts for liquids in a beverage dispensing apparatus, of a type comprising at least one tubular body, said one or more delivery ducts and at least one conveying duct for a forced flow of a cooled liquid being housed therein, characterized in that said at least one tubular body comprises at least one inflow section for said cooled fluid, said inflow section being fluidically communicated with said at least one conveying duct, and at least one outflow section for said cooled fluid, said at least one outflow section being placed at a higher height than said at least one inflow section.

2. The device according to claim 1, characterized in that said at least one inflow section is implemented by a three-way pipe joint, one opening of which is fluidically connected to at least one outlet section for said cooled fluid of said at least one conveying duct.

3. The device according to claim 1, characterized in that said at least one outflow section comprises a plurality of holes that are arranged in correspondence to at least one region of the side surface of said at least one tubular body.

4. The device according to claim 3, wherein said at least one tubular body is cylindrical and said holes are annularly arranged at a region of the side surface of the cylindrical tubular body.

5. The device according to claim 1, characterized in that said at least one outflow section comprises one or more vents that are placed at the end section of said at least one tubular body.

6. The device according to claim 5, wherein said end section of said at least one tubular body is arranged within a drawing column proximate to at least one beverage dispensing tap.

7. The device according to claim 1, characterized in that said conveying duct is fluidically connected to a refrigerating machine that is provided with means for generating said forced flow of a cooled fluid.

8. The device according to claim 1, characterized in that said cooled fluid is air.

9. The device according to claim 1, wherein said at least one tubular body is made of insulating material.

10. The device according to claim 9, wherein said at least one tubular body is made of plastic material.

11. The device according to claim 1, wherein said one or more delivery ducts, at least in the tract that is placed within said at least one tubular body, are made of metal.
